(19) United States
(12) Patent Application Publication
(10) Pub. No.: US 2011/0056896 A1
(43) Pub. Date: Mar. 10, 2011

(54) TOWEL HOLDER

(76) Inventors: Bistra M. Tzekova, Las Vegas, NV (US); Vassil K. Tzekov, Las Vegas, NV (US)

(21) Appl. No.: 12/877,009

(22) Filed: Sep. 7, 2010

Related U.S. Application Data
(60) Provisional application No. 61/240,268, filed on Sep. 7, 2009.

(51) Int. Cl. A47K 10/04; F16B 47/00

(52) U.S. Cl. 211/45

(57) ABSTRACT

A holder for sheetlike objects is attachable to vertical surfaces such as walls, shower doors and frames, and cabinet faces. Formed into a spiral holder and planar base using a length of spring steel, the holder receives the sheetlike object within a receiving passageway formed between inner and outer spiral bands. A biasing of the inner spiral band against the outer spiral band selectively secures the sheetlike object within the receiving passageway, such biasing enhanced by a biasing surface formed at a terminus of the inner spiral band. Release is initiated by application of a tugging force to the sheetlike object, the tug directed downwardly and along the central vertical axis of the holder. The combined downward and lateral movement thus initiated permits the withdrawal of the inserted sheetlike object from within the receiving passageway.

### RELATED APPLICATIONS

The present application claims priority under 35 U.S.C. §119(e) to U.S. Provisional Patent Application Ser. No. 61/240,268, filed Sep. 7, 2009, which is incorporated by reference herein.

### BACKGROUND OF THE INVENTION

1. Field of the Invention

The present invention relates to holders of sheet-form materials mounted on vertical surfaces. More specifically, the present invention relates to holders of the type permitting towels and the like to be easily slid into the holder by the force of insertion and easily removed upon application of a vertical tug by a user.

2. Description of the Related Art

Conventional towel holders are frequently bar-shaped, and permanently attached to a wall at each end of the bar holder, which is located about 2 or 3 inches from the mounting wall to provide room for the draped towel. By permitting the towel to freely hang, the towel is readily available to be removed for use. Unfortunately, such easy removal also results in the towel easily slipping from the mounting bar, falling to the floor. In addition, the space required to mount the projecting bar is not always available at the location that would be most convenient for the user.

### DISCLOSURE OF THE INVENTION

The present invention relates to holders for towels or the like, that is a new and useful improvement—different in comparison to known approaches. The present invention is well suited for use with fabric articles, such as towels, cloths, and the like.

The present inventive holder solves a common hygienic problem experienced with presently available bar and ring holders—unlike with these types of holders, when using the present, inventive holder, the towels will not fall off, landing on the floor. Also, some holders utilize hooks, and towels can be damaged as a result of forcing the towel onto the hook, placing a hole in the fabric. Moreover, the holder of the present invention has a neat appearing and an esthetic look.

The present inventive holder is easy to use, is durable in service, and marks a general improvement of the holder and hanger art.

In a further aspect of the present invention a holder for securing sheetlike objects to a support surface, comprising: a substantially planar base; and a spiral holder attached to and extending from said base, said spiral holder comprising: an outer spiral band, and an inner spiral band attached to and extending from said outer spiral band, an outer surface of said inner spiral band spaced from an inner surface of said outer spiral band in a manner defining a receiving passageway located therebetween, said receiving passageway selectively receiving and securing said sheetlike objects.

In a still further aspect of the present invention a gravity-biased holder for sheetlike material, comprising a length of spring steel which comprises: a base having a back carrying fastener enabling the selective attachment of said holder to a substantially vertically oriented supporting surface; and a spiral holder comprising: an outer spiral band attached to and extending in a curvilinear manner from said base, and an inner spiral band attached to and extending in a curvilinear manner from said outer spiral band, said outer spiral band and said inner spiral band spaced apart in a manner defining a receiving passageway located therebetween to selectively receive a portion of said sheetlike material.

It is to be understood that the invention is not limited in its application to the details of construction and the arrangement of components described hereinafter and illustrated in the drawing figures. Those skilled in the art will recognize that various modifications can be made without departing from the scope of the invention.

### BRIEF DESCRIPTION OF THE DRAWINGS

Embodiments in accordance with the present invention are described below in connection with the accompanying drawing figures.

FIG. 1 is a perspective view of a holder oriented as typically mounted upon a vertical support surface in accordance with the present invention.

FIG. 2 is a front elevated view of a holder as depicted in FIG. 1.

FIG. 3 is a side elevation view of a holder as depicted in FIG. 1.

FIG. 4 is a perspective view, with portions shown in phantom, of a holder retaining a towel or the like with arrows depicting the manner of insertion in accordance with the present invention.

FIG. 5 is a sectional view taken along line 5-5 of FIG. 4 of a holder and towel or the like received therein.

FIG. 6 is a view similar to FIG. 4 with arrows depicting the manner of removal of the towel or the like by a user in accordance with the present invention.

### DETAILED DESCRIPTION OF THE PREFERRED EMBODIMENTS

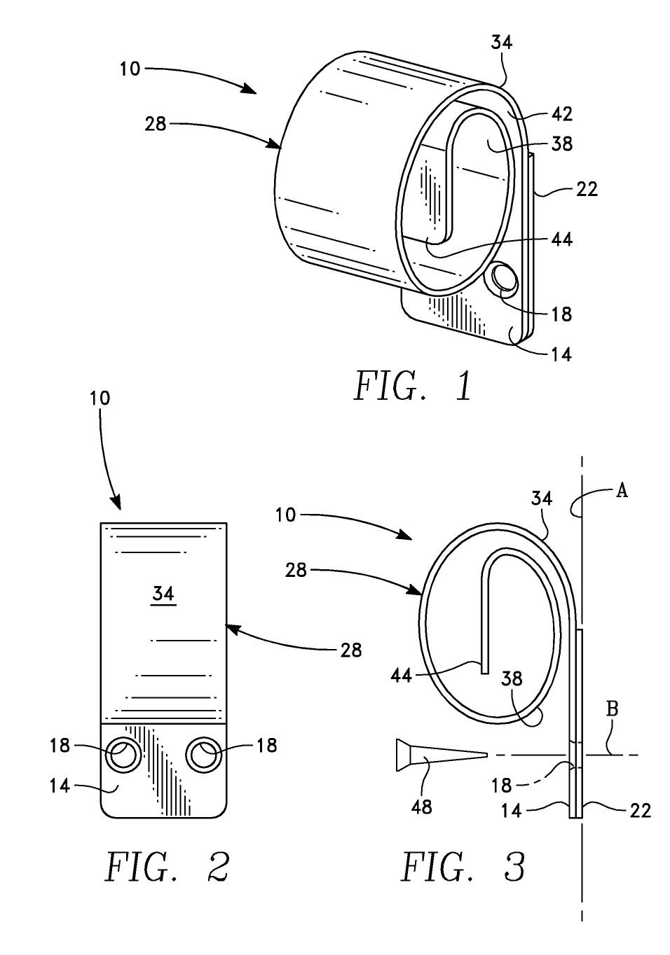

Reference is now made to the drawings wherein like structures refer to like parts throughout. In FIG. 1 a presently preferred embodiment shows a towel holder 10 in an orientation permitting attachment to a vertical support surface, such as a wall, cabinet face, shower door or door frame, and the like. Preferably fabricated out of a metal such a spring steel, the towel holder 10 includes a substantially planar base 14 preferably provides an attachment surface on the towel holder 10 for attachment to such a vertical support surface.

A pair of apertures 18 (only one shown in FIG. 1—see FIG. 2, also) are formed in the base 14 enabling use of fasteners (not shown in FIG. 1) where desired to secure the towel holder 10 to such vertical support surface. Alternatively or in addition to such use of fasteners, an adhesive surface 22 is provided on an outer surface of the base 14.

Extending from the substantially-planar base 14 in a coiled manner, the metal band forms a spiral holder 28, having an outer spiral band 34 and an inner spiral band 38 that cooperatively form a receiving passageway 42 permitting objects to be placed therebetween (not shown in FIG. 1). The inner spiral band 38 terminates in a substantially planar biasing surface 44.

In FIG. 3 the towel holder 10 is shown as if positioned on and attached to a planar surface extending in a vertical axis A. A fastener 48 is aligned with the fastener aperture 18, forming an axis B that is substantially perpendicular to axis A. The adhesive surface 22 is attached to the planar surface, further securing the attachment of the towel holder 10 to the planar surface.

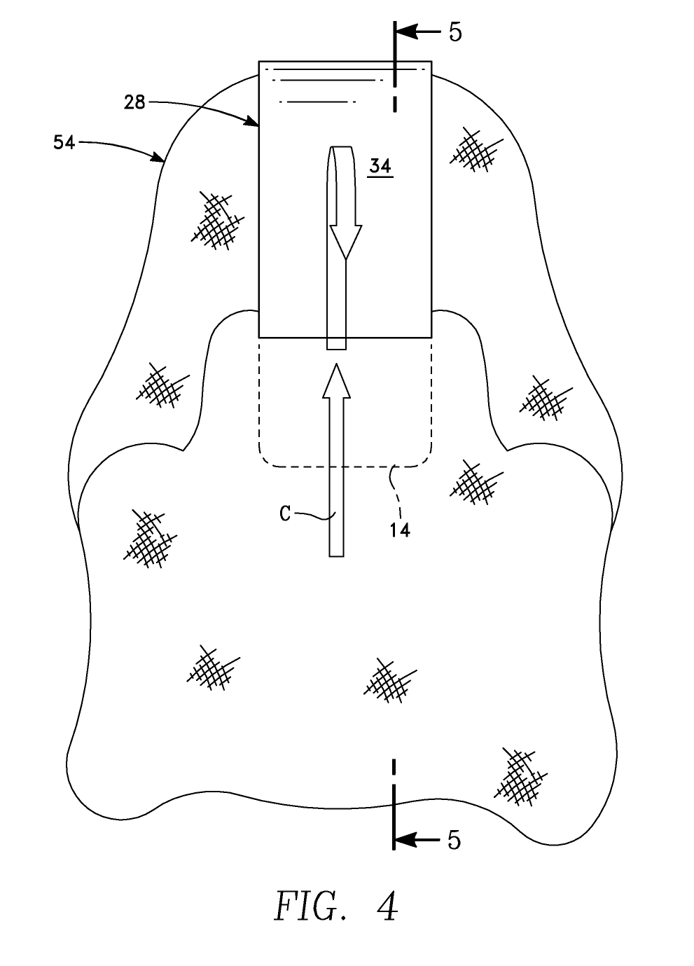

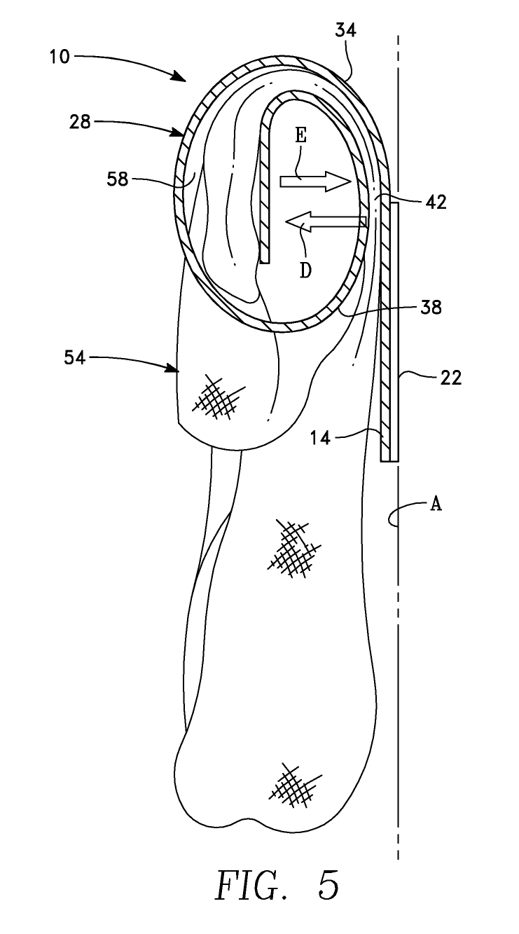

In FIG. 4 a towel 54 is received within the spiral holder 28. Arrow C indicates the manner of receiving the towel 54, with the towel initially fed through the receiving passageway 42 and then within a vault 58, consisting of the area/space formed between the biasing surface 44 and the outer spiral band 34 (see FIG. 5). In this regard, although identified the “towel” 54, it is to be understood and appreciated that other fabric or sheet-like materials can also be utilized with the present invention, such as articles of clothing, bath robes, kitchen gloves and potholders—and where the article is thin, doubling the layers can assist in usage of the holder.

The manner in which the towel 54 (or like sheet-form article) is held within the spiral holder 28 is best explained with reference to FIG. 5. Upon entry of the towel 54 into the spiral holder 28, the towel passes through the receiving passageway 42 in a manner biasing the inner spiral band 38 in the direction of Arrow D, resulting in a widening of the receiving passageway 42.

The continued passage of the towel 54 results in an accumulation of the towel material in the area between the biasing surface 44 and the inner surface of the outer spiral band 34. Upon completion of the placement of the towel 54 within the spiral holder 28 the accumulated material exerts pressure upon the biasing surface 44 resulting in movement of the inner spiral band 38 in the direction of Arrow E, which in turn applies a clamping force against the material of the towel 54 lying within the receiving passageway 42. This clamping force is sufficient to resist the gravitational force applied to the towel material lying outside of the spiral holder 28 that would otherwise result in the towel 54 backing out of the spiral holder 28 and falling to the ground.

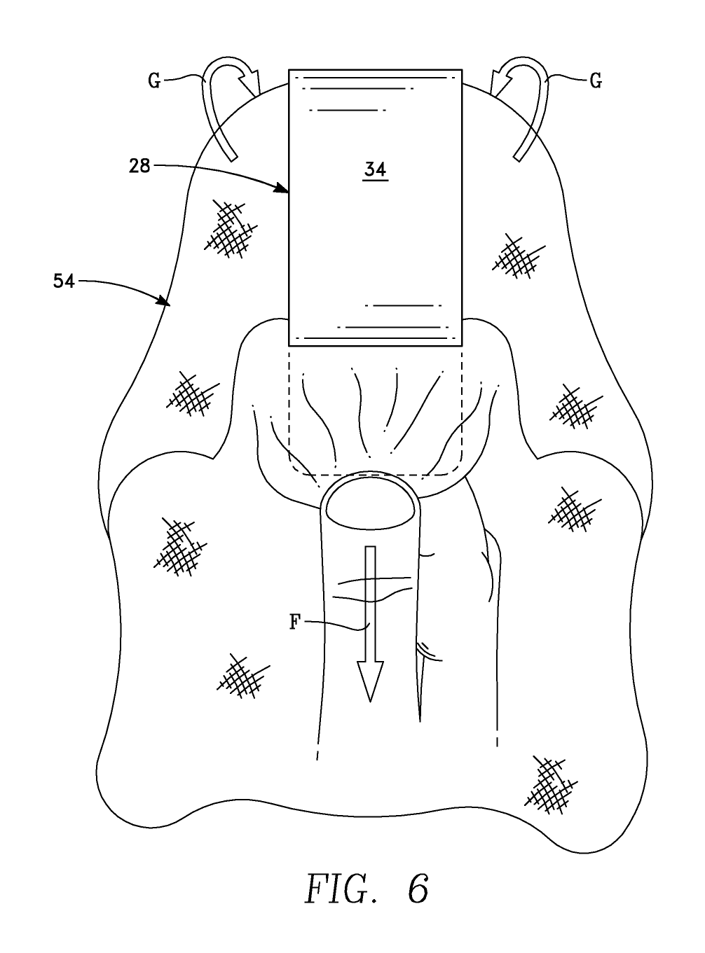

Removal of the towel 54 from within the spiral holder 28 is best explained with reference to FIG. 6. Removal is initiated by applying a force in the direction of Arrow F by, for example, having a user pull down along the central axis of the spiral holder 28. Upon this application of force in the direction of Arrow F the front portion of the towel 54—the portion furthest within the spiral holder 28, initiates movement in the direction of arrows G.

Such towel movement includes a lateral component—not merely vertical, and this off-vertical component of movement also occurs within the receiving passageway 42. The smooth surfaces of the receiving passageway that had applied the clamping force that had resisted vertical (downward) movement would not so-resist sliding, lateral movement. Such movement, which also includes a sliding downward movement, is sufficient to release the clamped towel fabric from within the receiving passageway 42. The continued pulling on the towel 54 in the direction of Arrow F results in all of the towel material exiting the spiral holder 28—with the towel 54 entirely free of the towel holder 10.

The coiled metal band with curvature automatically guides and grabs the cloth article. As a result of the spring-like quality of the metal strips, the coiled band responds to downward pull of the article as a result of its weight, by automatically “gripping” the towel or other article, holding it in place. Such spring-like gripping action greatly differs from previous holders where reliance was on frictional forces to hold the towel or like article in place on the holder.

The present coiled-band holder is of a non-breakable, simple design, and is anticipated to be inexpensive to produce. This coiled-band holder, preferably fabricated out of 18-gauge stainless steel, can be easily mounted on the desired surface, using tape, screws, nails, and the like. A presently preferred embodiment of this coiled-band holder has a height of 1¼ inches, a width of 1 inch, and a depth of 1¼ inches.

A presently preferred manner of using this coiled-band holder is as follows:

Holding the cloth on either side of the coiled-band holder, slide in the cloth from the bottom of the holder and move it up within the coiled band to a position where the leading edge of the cloth lies in front of the inner coil, with the adjacent lengths of cloth draped on each side of the coiled-band holder. The length of cloth curved within the coils of the holder, applies pressure to the coil, resulting in an “automatic grip” of the cloth by the coiled-holder, holding the cloth and preventing it from backing out of the holder. When a user desires to release the cloth from the coiled-band holder, the user need only provide a downward tug on a section of the cloth lying directly below the coiled holder to obtain the immediate release of the cloth.

The present coiled-band holder can be used in the kitchen, bathroom, trailer, motor home, work shop, garage, back yard, by the pool, and so on. The towel or similar cloth article is easily placed within the holder, and thereafter securely held in place, pending the subsequent, easy removal when required by a user.

Our invention has been disclosed in terms of a preferred embodiment thereof, which provides a towel holder that is of great novelty and utility. Various changes, modifications, and alterations in the teachings of the present invention may be contemplated by those skilled in the art without departing from the intended spirit and scope thereof. It is intended that the present invention encompass such changes and modifications.

We claim:

1. A holder for securing sheetlike objects to a support surface, comprising:
a substantially planar base; and
a spiral holder attached to and extending from said base, said spiral holder comprising:
an outer spiral band, and
an inner spiral band attached to and extending from said outer spiral band, an outer surface of said inner spiral band spaced from an inner surface of said outer spiral band in a manner defining a receiving passageway located therebetween, said receiving passageway selectively receiving and securing said sheetlike objects.

2. A holder as described in claim 1, wherein said planar base and said spiral holder comprise a unitary length of spring steel.

3. A holder as described in claim 2, wherein said planar base and said spiral holder comprise a unitary length of stainless steel.

4. A holder as described in claim 2, wherein a terminus of said inner spiral band comprises a biasing surface.

5. A holder as described in claim 4, wherein said biasing surface is substantially planar.

6. A holder as described in claim 4, wherein said biasing surface is spaced from said outer spiral band in a manner defining a vault located therebetween, said vault selectively receiving and accumulating said sheetlike objects.

7. A holder as described in claim 6, wherein said base has at least one fastener aperture formed therein.

8. A holder as described in claim 6, wherein an outer surface of said base comprises an adhesive surface.

9. A holder as described in claim 8, wherein said base has at least one fastener aperture formed therein, and further comprising a fastener, said fastener selectively received within said fastener aperture upon attachment of said holder to said support surface.

10. A holder as described in claim 9, wherein said support surface is a substantially vertical support surface.

11. A gravity-biased holder for sheetlike material, comprising a length of spring steel which comprises:
a base having a back carrying fastener enabling the selective attachment of said holder to a substantially vertically oriented supporting surface; and
a spiral holder comprising:
an outer spiral band attached to and extending in a curvilinear manner from said base, and
an inner spiral band attached to and extending in a curvilinear manner from said outer spiral band, said outer spiral band and said inner spiral band spaced apart in a manner defining a receiving passageway located therebetween to selectively receive a portion of said sheetlike material.

12. A gravity-based holder as described in claim 11, wherein a terminus of said inner spiral band comprises a biasing surface.

13. A gravity-based holder as described in claim 12, wherein said biasing surface is of a substantially planar configuration.

14. A gravity-based holder as described in claim 13, wherein said biasing surface is spaced from said outer spiral band in a manner defining a vault located therebetween, said vault selectively receiving and accumulating said sheetlike objects.

15. A gravity-based holder as described in claim 14, wherein said back carrying fastener comprises a substrate attached to said base, said substrate having an adhesive surface formed thereon.

16. A gravity-based holder as described in claim 14, wherein said base has at least one fastener aperture formed therein, and further comprising a fastener, said fastener selectively received within said fastener aperture upon attachment of said holder to said support surface.
